(19) United States
(12) Patent Application Publication
(10) Pub. No.: US 2014/0262621 A1
(43) Pub. Date: Sep. 18, 2014

(54) Step Ladder

(71) Applicant: Hailo-Werk Rudolf Loh GmbH & Co. KG, Haiger (DE)

(72) Inventors: Gerhard Müller, Burbach (DE); Rudolf Pfeifer, Mudersbach (DE); Gerd Weinhold, Bad Berleburg (DE)

(21) Appl. No.: 13/832,257

(22) Filed: Mar. 15, 2013

(51) Int. Cl. E06C 1/383

(52) U.S. Cl. CPC E06C 1/383
USPC 182/180.1

(57) ABSTRACT

A folding step ladder includes a climbing part pivotally connected to a supporting part. Each foot of the ladder has a first part and a second part. The first part has first connecting structures to connect to one of the side members of the step ladder, and second connecting structures to connect to the second part. The second part has connecting structures for connection to the second connecting structures and a standing surface via which the ladder foot rests on the underlying surface. All of the first parts and at least two second parts of the feet are identical; moreover, in relation to the second parts of the ladder feet on the supporting part, the second parts of the ladder feet on the climbing part are fitted on the first parts of the ladder feet such that they have been rotated through 180° in relation to the first parts.

### FIELD OF THE INVENTION

The present invention relates to a ladder and, in particular, a step ladder with a set of folding steps.

### BACKGROUND

Step ladders are generally known. In a conventional configuration, the standing surfaces of the second parts of the ladder feet of the step ladder disclosed in said document are oriented such that they are located parallel to the underlying surface and thus have as large as possible surface area of contact with the underlying surface. The second parts of the ladder feet are formed on the first parts in a plastic state. The second parts are produced from a softer plastics material than the first parts. The side members of the climbing part of the ladder taper toward one another in the upward direction. The climbing part is therefore in what is often referred to as an “A” shape. In order to compensate for the resulting inclination of the right side member and of the left side member, the second parts of the ladder feet are designed in the form of wedges, or at least in a wedge-like manner. The right ladder foot and the left ladder foot differ. The designs of the first part of the right foot and of the left foot differ. The right foot and left foot are therefore different. At least three tools are therefore necessary in order to produce the feet: two tools for producing the first parts and a further tool for fitting, and forming, the second parts of the ladder feet.

In addition, the climbing part and the supporting part, insofar as can be ascertained, may be of identical construction. The two ladder parts, in the opened-out state of the ladder, are at the same angle in relation to the underlying surface. It is therefore possible to select identical ladder feet for the two ladder parts, these ladder feet also allowing for the inclination of the ladder parts in relation to the underlying surface. This is the case because an abutment surface of the first parts, against which the second parts of the ladder feet butt, is not perpendicular to a longitudinal axis of the side members; rather, in relation to a surface perpendicular to the longitudinal axis, it is inclined about an axis parallel to the rungs of the ladder.

Some leaning ladders include ladder feet which likewise comprise a first part and a second part. The second part, clearly, has a wedge-like portion which projects beyond the first part. This wedge-like portion makes it possible to compensate for the inclination of the side members of an A-shaped leaning ladder, in order that the standing surfaces of these second parts can have a large surface area resting on the underlying surface.

These conventional ladders, however, suffer from several disadvantages. For example, none provides a solution as to how, in the case of a step ladder having a climbing part and a supporting part with different degrees of inclination in relation to the underlying surface, it is possible to design ladder feet which, on the one hand, have the largest possible area of contact with the underlying surface in the opened-out state of the ladder and, on the other hand, can be produced using the smallest possible number of tools. Thus, it would be desirable to provide such a solution.

### SUMMARY OF THE INVENTION

The present invention relates to a step ladder, in particular a set of folding steps, having a climbing part and a supporting part, which are connected to one another via at least one pivoting articulation. Both the climbing part and the supporting part here have side members, ladder feet being fitted at the one, first ends thereof, remote from the pivoting articulation. These ladder feet allow the step ladder, in the opened-out state, to rest on an underlying surface. Each ladder foot has a first part and a second part. The first part has first connecting structures, for connection to one of the side members of the step ladder, and second connecting structures, for connection to the second part, and the second part has connecting structures, for connection to the second connecting structures, and a standing surface, by means of which the ladder foot, in the opened-out state of the step ladder, rests on the underlying surface.

The object is achieved according to the invention in that all the first parts and at least two second parts of the ladder feet are identical, and in that, in relation to the second parts of the ladder feet on the supporting part, the second parts of the ladder feet on the climbing part are fitted on the first parts of the ladder feet in a state in which they have been rotated through 180° in relation to the first parts.

Further configurations of the invention can be gathered from the dependent claims.

According to the invention, all the second parts of the ladder feet may be identical. It is also likewise possible, however, to use two pairs of two types of second parts, wherein the types of second parts are axis-symmetrical to one another and the axis of symmetry runs in the longitudinal direction of the side members. The second parts of the first type are then fitted, for example, on the right side member of the climbing part and on the left side member of the supporting part. The second parts of the second type are then fitted, for example, on the left side member of the climbing part and on the right side member of the supporting part. Such a practice of fitting ladder feet which have two types of second part makes it possible to compensate for both the inclination between the right side member and the left side member and for the different degrees of inclination between the climbing part and the underlying surface and the supporting part and the underlying surface.

### BRIEF DESCRIPTION OF THE DRAWINGS

Further features of the present invention will be explained by way of the following description, with reference to the accompanying figures, in which:

FIG. 1 shows a ladder foot for a climbing part, as seen from the side,

FIG. 2 shows the ladder foot from FIG. 1, as seen from the rear,

FIG. 3 shows the ladder foot from FIGS. 1 and 2, as seen in section along line III-III in FIG. 2,

FIG. 4 shows the ladder foot from FIGS. 1 to 3, as seen from beneath,

FIG. 5 shows the ladder foot from FIGS. 1 to 4, as seen from the front,

FIG. 6 shows the ladder foot from FIGS. 1 to 5, as seen from the direction of the arrow VI in FIG. 1,

FIG. 7 shows a ladder foot for a supporting part, as seen from the side,

FIG. 8 shows the ladder foot from FIG. 7, as seen from the rear,

FIG. 9 shows the ladder foot from FIGS. 7 and 8, as seen in section along line IX-IX in FIG. 8,

FIG. 10 shows the ladder foot from FIGS. 7 to 9 as seen from beneath,

FIG. 11 shows the ladder foot from FIGS. 7 to 10, as seen from the front,

FIG. 12 shows the ladder foot from FIGS. 7 to 11, as seen from the direction of the arrow XII in FIG. 7, and

FIG. 13 shows a set of folding steps with the ladder feet according to FIGS. 1 to 12.

Like reference numerals have been used to identify like elements throughout this disclosure.

### DETAILED DESCRIPTION OF THE INVENTION

The set of folding steps S, which is illustrated in FIG. 13, has a climbing part 1 and a supporting part 2, which are connected to one another in a pivotable manner. The climbing part has side members 11, which are connected to one another via steps 12. The ladder feet 3 for the climbing part are fitted at the lower ends of the side members 11. The supporting part likewise has side members 21, which are connected to one another via transverse struts 22. The lower ends of the side members 21 are likewise provided with ladder feet 3. The climbing part 1 and the supporting part 2, in the opened-out state of the set of folding steps S, enclose angles of different magnitudes with the underlying surface. The two ladder feet 3 of the climbing part 1 and the two ladder feet of the supporting part 2 are configured such that the standing surfaces of all the ladder feet 3 can rest fully on the underlying surface when the set of folding steps S has been opened out.

The ladder feet 3, which are illustrated in FIGS. 1 to 12, differ, but are constructed from identical parts, that is to say from a first part 31 and a second part 32.

The first parts 31 of the ladder feet 3 are formed by caps which are plugged onto the lower end of the side members 11, 21. The caps have a side wall 315, and these side walls enclose the lower ends of the side members 11, 21. The side walls 315 thus form first connecting structures, which serve for connecting the first ladder parts 31 to the side members 11, 21. A base 316 of the caps forms an abutment surface 314, against which the second parts 32 of the ladder feet 3 butt. The abutment surface 314 is inclined by an angle in relation to a longitudinal direction of the side members 11, 21. The base contains holes 313, which form second connecting structures of the first parts 31, these second connecting structures being provided for connection to the second parts 32.

The second parts 32 of the ladder feet 3 are essentially in the form of wedges. Protuberances 323 are provided on the upper sides of the second parts, these upper sides being directed toward the first parts 31, and the protuberances serve for connection to the first parts 31 and form connecting structures of the second parts 32. The protuberances 323 are pressed into the holes 313. An underside of the second parts 32 forms the standing surface 322 of the ladder.

Both the first parts 31 and the second parts 32 have surface symmetry in relation to the surfaces which are denoted by the section surface in FIG. 2 and the section surface IX-IX in FIG. 8.

The ladder feet 3 for the climbing part according to FIGS. 1 to 6 and the ladder feet 3 for the supporting part according to FIGS. 7 to 12 differ merely in that the second parts 32, in the case of the climbing part 1, are fitted on the first parts 31 in a first mounting position and, in the case of the supporting part 2, are fitted on the first parts 31 in a second mounting position. In the second mounting position, the second part 32 is fitted on the first part 31 in a state in which it has been rotated through 180° in relation to the first part 31. This changes the angle between the standing surface 322 and the longitudinal direction 1 of the side members 11, 21. In the case of the ladder foot for the climbing part, this angle is denoted by α1; in the case of the ladder foot for the supporting part, it is denoted by α2. The different angles α1 and α2 make it possible to compensate for the different degrees of inclination of the climbing part 1 and of the supporting part 2 in relation to the underlying surface, in order to achieve surface-area abutment of the bearing surface 322 on the underlying surface.

We claim:

1. A folding step ladder (S) comprising:
a climbing part (1); and
a supporting part (2), the climbing part and the supporting part being connected to one another via at least one pivoting articulation,
wherein both the climbing part (1) and the supporting part (2) have side members (11, 21), ladder feet (3) being fitted at the a first end thereof, remote from the pivoting articulation, and allowing the step ladder, in the opened-out state, to rest on an underlying surface, and wherein each ladder foot (3) has a first part (31) and a second part (32), the first part (31) having first connecting structures (311) for connection to one of the side members (11, 21) of the step ladder (S) and second connecting structures (312) for connection to the second part (32), and the second part has connecting structures (321) for connection to the second connecting structures (312) and a standing surface (322), by means of which the ladder foot (3), in the opened-out state of the step ladder (S), rests on the underlying surface, wherein all the first parts (31) of the ladder feet (3) and all the second parts (32) of the ladder feet (3), or the second parts (32) of the ladder feet (3), are in identical pairs, and in that, in relation to the second parts (32) of the ladder feet (3) on the supporting part (2), the second parts (32) of the ladder feet (3) on the climbing part (1) are fitted on the first parts (31) of the ladder feet (3) in a state in which they have been rotated through 180° in relation to the first parts.

2. The step ladder according to claim 1, wherein an angle (α1) between the standing surface (322) of the second parts (32) of the ladder feet (3) on the climbing part (1) and a longitudinal direction (1) of the side members (11) of the climbing part (1) on which these ladder feet (3) are fastened differs from an angle (α2) between the standing surface (322) of the second parts (32) of the ladder feet (3) of the supporting part (2) and a longitudinal direction (1) of the side members on which these ladder feet (3) are fastened.

3. The step ladder according to claim 1, wherein the first parts (31) have an abutment surface (314), against which the second parts (32) butt, and in that an angle ((3) between the abutment surfaces (314) and the longitudinal direction of the side members (11, 21) is not equal to 90°.

4. The step ladder according to claim 3, wherein the second parts (32) have a wedge-form portion projecting beyond the abutment surface (314) of the first parts (31).

5. The step ladder according to claim 4, wherein a spacing between the standing surface (322) of the second parts (329) and the abutment surface (314) of the first parts (31) of the ladder feet (3) decreases in a direction from the climbing part (1) to the supporting part (2).

6. The step ladder according to claim 1, wherein the first parts (31) and the second parts (32) possess surface symmetry.
